(19) United States
(12) Patent Application Publication
(10) Pub. No.: US 2009/0083490 A1
(43) Pub. Date: Mar. 26, 2009

(54) System to Improve Data Store Throughput for a Shared-Cache of a Multiprocessor Structure and Associated Methods

(75) Inventors: Derrin M. Berger, Hyde Park, NY (US); Michael F. Fee, Cold Spring, NY (US); Park-kin Mak, Poughkeepsie, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES COPRORATION, Armonk, NY (US)

(21) Appl. No.: 11/861,814

(22) Filed: Sep. 26, 2007

(51) Int. Cl. G06F 12/08

(52) U.S. Cl. 711/130; 711/E12.038

(57) ABSTRACT

A system to improve data store throughput for a shared-cache of a multiprocessor structure that may include a controller to find and compare a last data store address for a last data store with a next data store address for a next data store. The system may also include a main pipeline to receive the last data store, and to receive the next data store if the next data store address differs substantially from the last data store address. The system may further include a store pipeline to receive the next data store if the next data store address is substantially similar to the last data store address.

### FIELD OF THE INVENTION

This invention relates to computer systems with shared data caches, and particularly to a system and for handling high processor store traffic and related methods.

### BACKGROUND OF THE INVENTION

In a large shared memory multiprocessor system where two or more processors are assigned the same task to perform, a shared data cache design offers superior performance over a private data cache design as more memory storage data can be kept in a shared cache than in smaller private caches with comparable aggregate cache sizes. However, when the shared data cache is responsible for handling storage updates from multiple processors, it is important for the shared data cache to process these storage updates, otherwise known as processor stores, in a timely manner so as to limit these processor stores from backing up to the processors whereby the processors must temporarily halt executing instructions until their stores are drained. This can compromise the shared data cache design's performance advantage over a private cache design.

A common prior art teaching for enhancing store throughput on a shared data cache design is to organize the shared cache into a number of address-based slices that operate independently from each other and therefore there can be as many stores processed simultaneously as there are number of the address-based slices. The problem with this solution is that it is often impractical to physically package the minimum required number of address-based slices as a slice typically consists of hardware for returning cache hit data to each processor as well as retrieving cache miss data from memory or from other shared data caches in the multiprocessor system.

When this constraint exists and the minimum required number of address-based slices for store throughput is not attained, it is then necessary to attain the desired store throughput in the slice within this constraint. In a typical cache design that is sliced one or more times, there is a single pipeline within each slice whereby all the received storage operations, such as fetches and stores in the slice, go down to determine if the address of the operation exists in the cache or not by performing a search of the cache directory. Also typical in a cache design, the actual data cache is organized into multiple sub-line interleaves to optimize pipe operation throughput by minimizing the average cache busy time and increasing the availability of the cache interleave.

In an associative cache design, it is usually necessary to know in which compartment (set) the cache line address exists before the data belonging to the cache line address can either be accessed for a fetch operation or modified for a store operation. Typically, a store operation would have to first perform a directory look-up to determine if the targeted address hits in the cache and to collect information that identifies which set holds the data. To accomplish this, system control resources and pipeline are utilized to access the cache directory, which carries with it a number of drawbacks.

For example, there can be conflict for pipeline access. The pipe (pipeline) which accesses the cache directory is shared among a number of requesters, e.g. processor stores, processor fetches, input/output stores, input/output fetches, etc. Access to the pipe is serialized for all operations as it is usually the only means to retrieve cache directory hit and miss information as well as the cache directory hit set information. When there is a high rate of operations being issued to the shared cache from the processors that are directly attached, system performance will degrade as most of these operations will encounter queuing delays in order to gain pipe access.

Another drawback can occur when store throughput is not optimized. If a processor sends a stream of back to back sub-line length stores to the same cache line, cycles are wasted performing directory lookups for each store as the set information has already been determined. These wasted pipe accesses could have been given to other requesters including requesters with a store operation.

Another drawback may involve stores with low priority. Typically, any task a processor performs usually generates a higher proportion of store operations relative to fetch operations. In addition when accessing the pipe, other requesters (processor fetches, remote shared cache miss fetches, input/output, etc.) are given preference over requesters with a store operation for performance reasons. This means that stores will have to wait longer to be processed, during which time the store stacks that queue up processor store operations prior to gaining pipe access will become full, and stores will back up all the way to the processors causing temporary stoppage of instruction executions until such time the stores start draining.

Unfortunately, such a system may not effectively and efficiently meet the storage needs of a multiprocessor structure using a shared-cache.

### SUMMARY OF THE INVENTION

In view of the foregoing background, it is therefore an object of the invention to provide a more efficient storage system that improves data store throughput for a multiprocessor structure using a shared-cache.

This and other objects, features, and advantages in accordance with the invention are provided by a system to improve data store throughput for a shared-cache of a multiprocessor structure. The system may include a controller to find and compare a last data store address for a last data store with a next data store address for a next data store. The system may also include a main pipeline to receive the last data store, and to receive the next data store if the next data store address differs substantially from the last data store address. The system may further include a store pipeline to receive the next data store if the next data store address is substantially similar to the last data store address.

The main pipeline may be accessed primarily for store operations needing cache directory accesses, and the store pipeline may be accessed primarily for store operations based upon availability of cache directory access hit information from a previous store operation. The main pipeline may receive the next data store based upon unavailability of local cache directory information. Both the main pipeline and store pipeline receive store operations needing direct access of a cache.

The system may also include a plurality of processors in communication with the controller, and a store stack in communication with each respective processor. The system may further include a next-store register at each store stack to hold a next store operation to be issued, and a last-store register at each store stack to hold a store operation currently being issued.

The controller may provide shared grant logic between the store stacks. The controller may use the shared grant logic to select a single store operation for the main pipeline from among available store operations. The controller may use the grant logic to choose a store operation command or non-store operation command to make a cache directory access and a cache access.

The store pipeline may receive the next data store by requesting direct access of a cache. The controller may include shared grant logic to select a single store operation for the store pipeline from among available store operations. The store pipeline may communicate the single store operation and the single store operation makes a direct access of the cache using the available cache directory hit information from a previous store operation.

Another aspect of the invention is a method to improve data store throughput for a shared-cache of a multiprocessor structure. The method may include finding and comparing a last data store address for a last data store with a next data store address for a next data store. The method may also include receiving the last data store in a main pipeline, and receiving the next data store in the main pipeline if the next data store address differs substantially from the last data store address. The method may further include receiving the next data store in a store pipeline if the next data store address is substantially similar to the last data store address.

### BRIEF DESCRIPTION OF THE DRAWINGS

FIG. 1 is a block diagram of a storage system in accordance with the invention.

FIG. 2 is a flowchart illustrating method aspects according to the invention.

FIG. 3 a block diagram illustrating one example of a set of main and store pipelines used for issuing store commands and storing data into a cache concurrently in accordance with the invention.

FIG. 4 is a block diagram illustrating one example of a more detailed depiction of a store pipeline used exclusively for storing data into a cache in accordance with the invention.

FIG. 5 is a block diagram illustrating one example of hardware used to determine if a store operation is valid by the compare used to determine if a store should be sent through the store pipeline in accordance with the invention.

### DETAILED DESCRIPTION OF THE PREFERRED EMBODIMENTS

The invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

As will be appreciated by one skilled in the art, the invention may be embodied as a method, system, or computer program product. Furthermore, the invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the invention may be written in an object oriented programming language such as Java, Smalltalk, C++ or the like. However, the computer program code for carrying out operations of the invention may also be written in conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

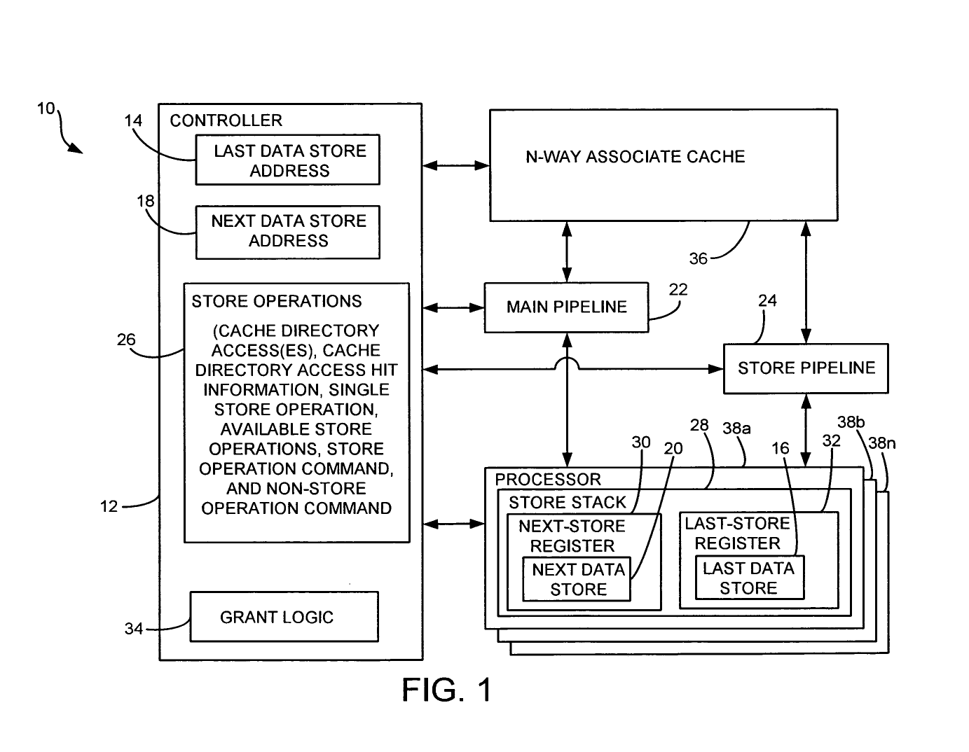

Referring initially to FIG. 1, a storage system 10 to improve data store throughput for a shared-cache of a multiprocessor structure is initially described. The system 10 includes a controller 12 which is a processor, software, and/or other logic circuitry as will be appreciated by those of skill in the art. The controller 12 finds and compares a last data store address 14 for a last data store 16 with a next data store address 18 for a next data store 20, for example. The system 10 also include a main pipeline 22 to receive the last data store 16, and to receive the next data store 20 if the next data store address 18 differs substantially from the last data store address 14. The system 10 further includes a store pipeline 24 to receive the next data store 20 if the next data store address 18 is substantially similar to the last data store address 14.

In one embodiment, the main pipeline 22 is accessed primarily for store operations 26 needing cache directory accesses, and accesses the store pipeline 24 primarily for store operations based upon availability of cache directory access hit information from a previous store operation. Further, the main pipeline 22 may receive the next data store 20 based upon local cache directory information.

In another embodiment, the system 10 also include a plurality of processors 38a-38n in communication with the controller 12, and a store stack 28 in communication with each respective processor. The store stack 28 further includes a next-store register 30 at each store stack to hold the next data store 20 to be issued, and a last-store register 32 at each store stack to hold the last data store 16 currently being issued, for example.

In another embodiment, the controller 12 provides shared grant logic 34 between the store stacks 28. The controller 12 uses the shared grant logic 34 to select a single store operation for the main pipeline 22 from among any available store operations, for instance. The controller 12 may also use the grant logic 34 to choose a store operation command or non-store operation command to make a cache 36 directory access and a cache access.

In another embodiment, the store pipeline 24 receives the next data store 20 by requesting direct access of a cache 36, and the cache may be an N-way associative cache. The controller 12 includes shared grant logic 34 to select a single store operation for the store pipeline 24 from among any available store operations, for example. The store pipeline 22 communicates the single store operation and the single store operation makes a direct access of the cache 36 using available cache directory hit information from the previous store operation.

As a result of the foregoing, the system 10 may elevate store throughput in a multiprocessor system with data caches that are shared by a subset, or all of, the processors in the system. This is achieved by implementing a split pipe design where a main pipeline 22 is accessed primarily for operations needing cache directory accesses, and at least one store pipeline 24 that is accessed primarily for store operations with pre-determined cache directory access hit information.

Additionally, the system 10 uses the controller 12 to compare addresses for consecutive store operations from the same store stack 28, e.g. Store Address FIFO stack, a processor's store operations are queued up in to determine if these store operations target the same cache line, and grant logic 34 to steer the store operation based on the address compare result to either the main pipeline 22 or the store pipeline 24. When a store operation accesses the main pipeline 22, the cache directory hit information is captured by grant logic 34 in the store pipeline 24 that remembers the information for each store stack 28 such that the store pipeline can provide the correct cache hit set to the store operation 26 in the store pipeline based on which store stack it came from.

Thus the system 10 provides improved main pipeline 22 efficiency and higher store throughput. For example, while the store pipeline 24 is being used, the main pipeline 22 is free to be used by other operations, including other store operations that are from different store stacks 28 which belong to other processors. This is also an advantage because store operations 26 typically have the lowest priority when being granted into the main pipeline 22.

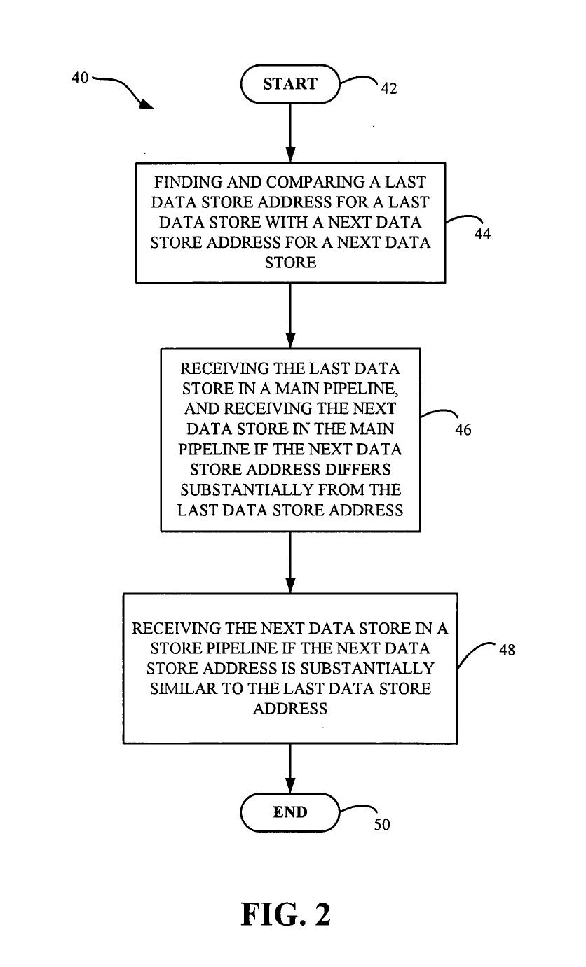

Another aspect of the invention is a method to improve data store throughput for a shared-cache of a multiprocessor structure, which is now described with reference to flowchart 40 of FIG. 2. The method begins at Block 42 and may include finding and comparing a last data store address 14 for a last data store 16 with a next data store address 18 for a next data store 20 at Block 44. The method may also include receiving the last data store 16 in a main pipeline 22, and receiving the next data store 20 in the main pipeline if the next data store address 18 differs substantially from the last data store address 14 at Block 46. The method may further include receiving the next data store 20 in a store pipeline 24 if the next data store address 18 is substantially similar to the last data store address 14 at Block 48. The method may end at Block 50.

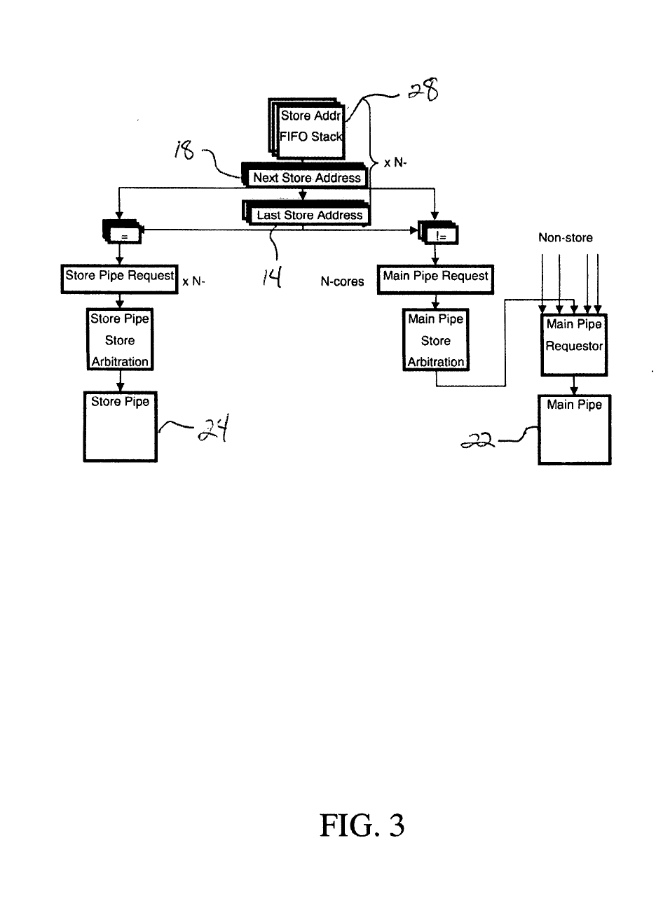

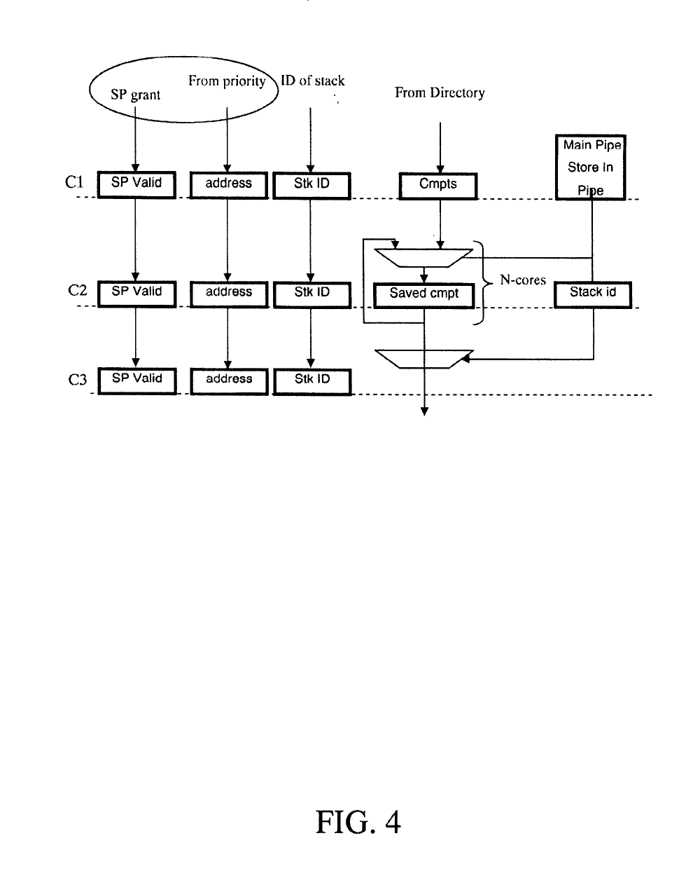

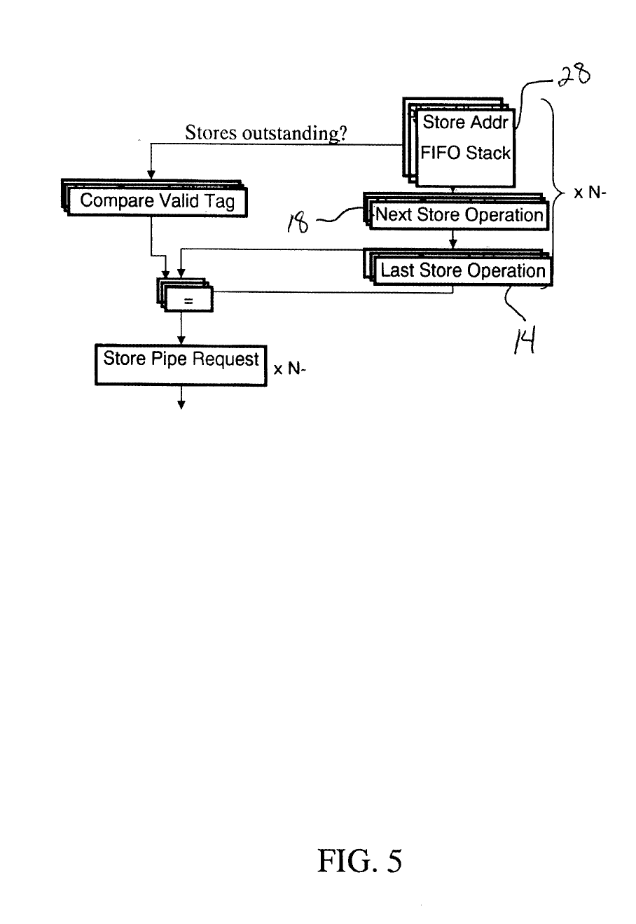

A prophetic example of how the system 10 may work is now described with additional reference to FIGS. 3-5. As processors in a large shared memory multiprocessor system drive storage updates into a shared cache 36, the data flow would follows store operations 26 that are dispatched in a “first-in-first-out” fashion from each processor's 38a-38n store stack 28, e.g. Store Address FIFO stack. As subsequent store operations 26 are granted through either the store pipeline 24 (auxiliary) or main pipeline 22 (primary), the next store operation to be issued is held in a dedicated processor-based “Next Store” register 30, while the preceding store operation (currently being issued) is also held in a dedicated “Last Store” register 32.

Before the next store operation 26 is granted to either pipeline, next data store address 18 is compared against the last data store address 14 (previous store operation). If the addresses do not compare, the store operation 26 is directed towards the main pipeline 22, such that it can request access to the local cache directory and obtain the cache compartment and directory state information. Once the determination is made that the store operation 26 should use the main pipeline 22, a request to grant logic 34 is made to select (arbitrate) a single store operation among the other “main pipeline” store operations from other store stacks 28. This chosen store operation 26 is then, in turn, sent to another set of arbitration logic within the grant logic 34 which will choose which command (the store or non-store operation) will proceed to make a cache directory access.

If the last data store address 14 and the next data store address 18 are substantially similar, the store operation 26 is directed towards the store pipeline 24, such that it can request making a direct access to the cache, circumventing the main pipeline 22. Once the determination is made that the store operation 26 will make use of the store pipeline 24, a request to grant logic 34 is made to select (arbitrate) a single store operation among the other “store pipeline” store operations. This chosen store operation 26 is then sent through the remainder of the store pipeline 24 and will make a direct access to the cache 36.

In this manner, consecutive store operations 26 from the store stack 28 to the same cache line only require the resource cost of a directory look-up on the first store operation of the sequence. Because the following store operations 26 to the same line can use the store pipeline 24, the main pipeline 22 and the local cache directories are made available to other operations, including store operations that may be granted from other processors and/or chips and that require the directory look-up cycle.

The sequence of sending a store operation 26 through the store pipeline 24 begins with a preceding store operation through the main pipeline 22. As the store operation 26 in the main pipeline 22 is executed, the address is used to make a cache directory look-up to determine which cache compartment (in an n-way associative cache) the data is to be stored to. This cache compartment is held in a dedicated register, one for each store stack 28 that can issue a store operation 26. This cache compartment register is updated with each main pipeline 22 store operation 26, and is not updated with any of the store pipeline 24 store operations. This ensures that for a given sequence of store operations 26 from the same store stack 28 to the same line, the compartment is looked up during the first store, saved for the remaining stores to the line, and will be overwritten on the next store operation to the main pipeline 22 for that store stack, (i.e. the first store operation of a sequence of consecutive store operations to a new line).

As a store pipeline 24 store operation 26 is granted through the grant logic 34, several stages of registers are used to make both the cache access itself, as well as access the information stored by the initial main pipeline 22 store. A valid bit and address are staged for several cycles and are used to directly access the cache 36 for any valid store pipeline 24 store operation 26. In addition, a store stack 28 identification (ID) field is also staged for several cycles. This stack ID is used to select the cache compartment from one of N number of registers (one per stack) that may hold valid compartments previously looked up and saved by a preceding store to the same cache line.

Because store operations 26 should be issued “in-order”, it should be impossible for a store pipeline 24 store to be issued ahead of its main pipeline 22 store operation to the same line (i.e. the first store operation 26 of the sequence). This ensures that if a main pipeline 22 store operation 26 is issued, the cache compartment information will be available for the next store operation on the following cycle. As in FIG. 3, the consecutive store operations 26 can be issued in back-to-back cycles as the address compare is done as a preceding store operation is being issued.

As store operations 26 are issued through either pipeline and the store stacks 28 are drained empty, the situation arises that the address of an old store operation, one that has already since been issued, is still held in the “Last Store” register 32, but should no longer be used to be compare against because the store operation has been completed and the cache line may have already been evicted out of the cache 36. For this reason, to avoid incorrectly sending a store operation 26 through the store pipeline 24 due to a false compare, a “Compare Valid” tag bit should be maintained. This bit is set whenever there are store operations 26 within the store stack 28 waiting to be processed. The “Compare Valid” tag bit is reset when there are no further store operations 26 within the store stack 28 waiting to be processed. Once the controller 12 detects that there are no longer any store operations 26 waiting to be processed, it assumes the last store operation in the stack is complete, and therefore the address in the “Last Store” register 32 does not contain a valid store operation. At that point, compares for the store pipeline 24 are not performed.

The system 10 can be implemented in software, firmware, hardware or some combination thereof. As one example, one or more aspects of the system 10 can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the system 10 can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that other modifications and embodiments are intended to be included within the scope of the appended claims.

That which is claimed is:

1. A system to improve data store throughput for a shared-cache of a multiprocessor structure, the system comprising:
a controller to find and compare a last data store address for a last data store with a next data store address for a next data store;
a main pipeline to receive the last data store, and to receive the next data store if the next data store address differs substantially from the last data store address; and
a store pipeline to receive the next data store if the next data store address is substantially similar to the last data store address.

2. The system of claim 1 wherein said main pipeline is accessed primarily for store operations needing cache directory accesses and said store pipeline is accessed primarily for store operations based upon availability of cache directory access hit information from a previous store operation.

3. The system of claim 1 wherein said main pipeline receives the next data store based upon unavailability of local cache directory information.

4. The system of claim 1 further comprising:
a plurality of processors in communication with said controller;
a store stack in communication with each respective processor;
a next-store register at each store stack to hold a next store operation to be issued; and
a last-store register at each store stack to hold a store operation currently being issued.

5. The system of claim 4 wherein said controller provides shared grant logic between the store stacks.

6. The system of claim 5 wherein said controller uses the shared grant logic to select a single store operation for said main pipeline from among available store operations.

7. The system of claim 6 wherein said controller uses the grant logic to choose a store operation command or non-store operation command to make a cache directory access and a cache access.

8. The system of claim 1 wherein said store pipeline receives the next data store by requesting direct access of a cache.

9. The system of claim 8 wherein said controller includes shared grant logic to select a single store operation for said store pipeline from among available store operations.

10. The system of claim 9 wherein said store pipeline communicates the single store operation and the single store operation makes a direct access of the cache using available cache directory hit information from a previous store operation.

11. A method to improve data store throughput for a shared-cache of a multiprocessor structure, the method comprising:
finding and comparing a last data store address for a last data store with a next data store address for a next data store;
receiving the last data store in a main pipeline, and receiving the next data store in the main pipeline if the next data store address differs substantially from the last data store address; and
receiving the next data store in a store pipeline if the next data store address is substantially similar to the last data store address.

12. The method of claim 11 further comprising:
accessing the main pipeline primarily for operations needing cache directory accesses; and
accessing the store pipeline primarily for store operations based upon availability of cache directory access hit information from a previous store operation.

13. The method of claim 11 further comprising receiving the next data store in the main pipeline based upon unavailability of local cache directory information.

14. The method of claim 11 further comprising:
providing a plurality of processors, and a store stack in communication with each respective processor;
holding a next store operation to be issued in a next-store register at each store stack;
holding a store operation currently being issued in a last-store register at each store stack;
selecting a single store operation for the main pipeline among available store operations using shared grant logic between the store stacks; and
choosing a store operation command or non-store operation command to make a cache directory access using the grant logic.

15. The method of claim 11 further comprising:
receiving the next data store for the store pipeline by requesting direct access of a cache;
selecting a single store operation for the store pipeline from among available store operations; and
communicating the single store operation via the store pipeline and the single store operation makes a direct access of the cache using available cache directory hit information from a previous store operation.

16. A computer program product embodied in a tangible media comprising:
computer readable program codes coupled to the tangible media for a shared-cache of a multiprocessor structure, the computer readable program codes configured to cause the program to:
find and compare a last data store address for a last data store with a next data store address for a next data store;
receive the last data store in a main pipeline, and receiving the next data store in the main pipeline if the next data store address differs substantially from the last data store address; and
receive the next data store in a store pipeline if the next data store address is substantially similar to the last data store address.

17. The computer program product of claim 16 further comprising program code configured to:
access the main pipeline primarily for operations needing cache directory accesses; and
access the store pipeline primarily for store operations based upon availability of cache directory access hit information from a previous store operation.

18. The computer program product of claim 16 further comprising program code configured to: receive the next data store in the main pipeline based upon unavailability of local cache directory information.

19. The computer program product of claim 16 further comprising program code configured to:
provide a plurality of processors, and a store stack in communication with each respective processor;
hold a next store operation to be issued in a next-store register at each store stack;
hold a store operation currently being issued in a last-store register at each store stack;
select a single store operation for the main pipeline from among available store operations using shared grant logic between the store stacks; and
choose a store operation command or non-store operation command to make a cache directory access using the grant logic.

20. The computer program product of claim 18 further comprising program code configured to:
receive the next data store for the store pipeline by requesting direct access of a cache;
select a single store operation for the store pipeline from among available store operations; and
communicate the single store operation via the store pipeline and the single store operation makes a direct access of the cache using available cache directory hit information from a previous store operation.
